(19) United States
(12) Patent Application Publication
(10) Pub. No.: US 2017/0317748 A1
(43) Pub. Date: Nov. 2, 2017

(54) VEHICLE POSITIONING BY VISIBLE LIGHT COMMUNICATION

(71) Applicant: MAGNA ELECTRONICS INC., Auburn Hills, MI (US)

(72) Inventor: Arno Krapf, Darmstadt (DE)

(21) Appl. No.: 15/583,112

(22) Filed: May 1, 2017

Related U.S. Application Data
(60) Provisional application No. 62/330,558, filed on May 2, 2016.

(51) Int. Cl. H04B 10/116; G08G 1/14; B60R 11/04

(52) U.S. Cl. CPC H04B 10/116; B60R 11/04; G08G 1/143

(57) ABSTRACT

A vehicle optical wireless data communication system includes a plurality of light sources disposed at a structure where vehicles travel. Each of the light sources emits visible light to illuminate the building or structure. Each of the light sources emits optical signals indicative of a location of the respective light source. A sensor is disposed at a vehicle and is operable to sense optical signals emitted by the light sources when the vehicle is in the vicinity of the light sources. Responsive to sensing by the sensor of optical signals emitted by at least one of the light sources, the sensor generates an output to a processor disposed at the vehicle. The processor processes the output of the sensor to determine a location of the vehicle relative to at least one of the light sources.

### CROSS REFERENCE TO RELATED APPLICATION

The present application claims the filing benefits of U.S. provisional application Ser. No. 62/330,558, filed May 2, 2016, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties. Indoor application solutions for optical wireless data communication including visible light communication (VLC) using LED lamps as data sources are known. Optical wireless data transmission between vehicles is also known.

### SUMMARY OF THE INVENTION

The present invention provides a vehicle optical wireless data communication system that provides location information to vehicles when the vehicles are driven in areas that do not allow for GPS systems to work effectively, such as parking structures and tunnels and the like. The vehicle optical wireless data communication system includes a plurality of light sources disposed at a structure where vehicles travel, with each of the light sources being operable to emit visible light to illuminate the building or structure, and with each of the light sources being operable to emit optical signals indicative of a location of the respective light source. A sensor (such as a light sensor or photo-sensing element or camera or the like) is disposed at each vehicle and is operable to sense optical signals emitted by the light sources. A processor at the vehicle is operable to process an output of the sensor to determine a location of the vehicle relative to at least one of the light sources.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras in accordance with the present invention;

FIG. 2 shows a top view of a vehicle driving through a tunnel with a positioning light signal lamp (PLSL) installed on the ceiling in accordance with the present invention;

FIG. 3 shows a parking structure lamp of the system of the present invention, shown with the illuminated segments increasing in space with the distance;

FIG. 4A is a plan view of a parking structure;

FIG. 4B is a plan view of the parking structure of FIG. 4A, shown with a plurality of PLSLs in accordance with the present invention;

FIG. 5 is a schematic showing a PLSL having an optical element that spreads the light from the lamp's LEDs in a sphere like manner; and

FIG. 6 shows a polarization scheme of illuminated segments around a PLSL in accordance with the present invention.

### DESCRIPTION OF THE PREFERRED EMBODIMENTS

A vehicle vision system and/or driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide display, such as a rearview display or a top down or bird's eye or surround view display or the like.

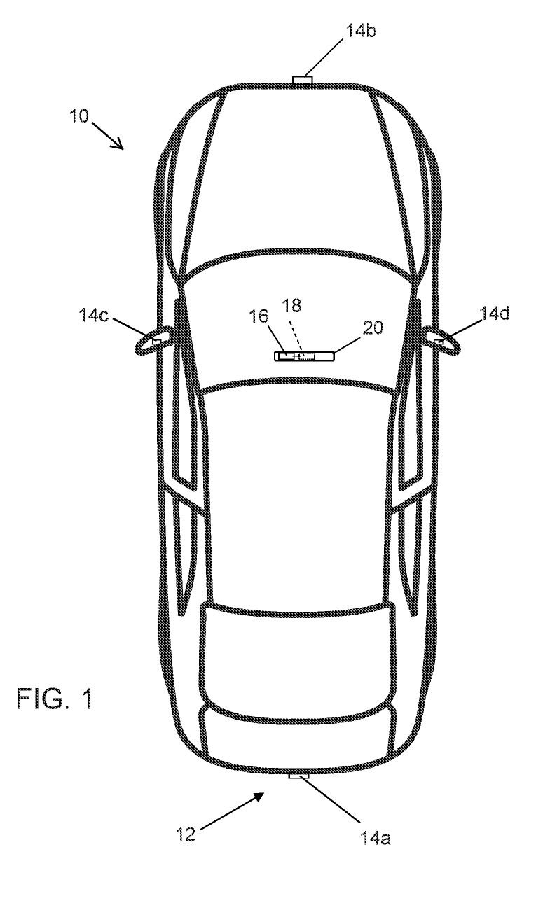

Referring now to the drawings and the illustrative embodiments depicted therein, a vehicle 10 includes an imaging system or vision system 12 that includes at least one exterior facing imaging sensor or camera, such as a rearward facing imaging sensor or camera 14a (and the system may optionally include multiple exterior facing imaging sensors or cameras, such as a forward facing camera 14b at the front (or at the windshield) of the vehicle, and a sideward/rearward facing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) or processor 18 that is operable to process image data captured by the camera or cameras and may detect objects or the like and/or provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

An optical wireless data transmission system can distinguish between directed wireless (mid-air) optical data transmission (which is typically done by using a LASER as transmitter emitting small directed beam and a photodiode as receiver (such as, for example, a PNZ334)) and more or less diffuse or not specially directed data transmission or broadcast typically using light emitting diodes of indoor illumination like lamps. In this case, the lamp serves both purposes, providing light to illuminate a room for humans to see and to provide a data stream, typically time coded white light having one channel. More sophisticated systems are able to modulate the red, green and blue light component and optionally invisible light such as near infrared (NIR) light (or channel) independently for achieving a higher bandwidth. In VLC frequency division, multiplexing (FDM) has been proven as an effective high bandwidth modulation method. Some LED types are limited to white light only. While the directed (LASER) solution is capable of transmitting data over many kilometers, such as up to around 15 km, even during severe weather situations, the non-directed solution is typically limited to a few meters because the SNR diminishes with the luminance, which diminishes with the distance to the light source (assuming a Lambertian emitter).

In U.S. patent application Ser. No. 15/376,818, filed Dec. 13, 2016 (Attorney Docket MAG04 P-2901), which is hereby incorporated herein by reference in its entirety, optical data transmission between a street light and a vehicle (V2X) using a timely modulated code, a code pattern modulated code or a combination of timely and pattern modulated codes, optionally using visual and/or infrared wavelengths or spectral bands, was suggested for doing a monodirectional or bidirectional optical data transmission. Monodirectional transmission may be done in a kind of broadcast, such as news, TV, radio, entertainment and traffic information. When done as a bidirectional system, the street light may have an additional camera for picking up light signals from vehicles, serving as optical internet access point or the like.

The present invention provides a more sophisticated solution using non directed as well as directed optical data transmission incorporated into street and facility (illumination) lights (or lamps) for vehicle positioning (orientation), particularly for use in places at which lamps are present and where there are no or not enough global positioning satellite signal(s) (common GPS) that can be received, such as at underground, under bridges, in tunnels, in dense cities and especially in parking structures, especially parking structures with multiple stories.

In vehicle tunnels and parking structures, there are typically multiple lamps installed for illuminating the structure. The lamps are at reasonable distances apart so that the structure's ground and walls are illuminated more or less evenly. Sometimes the walls and the ceiling are white to improve the reflectance, so that the illumination is better. In tunnels, the illumination at the entrances may be stronger to ease the eye adaption of drivers entering and exiting the tunnel. This may be done by having stronger lights or the lamps are being installed more densely (closer together). In all of these situations, there is nearly no area in these structures which is fully in the dark. Since GPS is not working well in these structures (because the electromagnetic waves are blocked by the structure), aided, automated and semi-automated vehicle drive guiding systems, such as systems of unmanned (valet) parking vehicles, are limited to the scene detection of the vehicle's onboard sensors for navigating through the structure. The driving task is to navigate through the static predictable scene and to do collision hazard avoidance given by the non-static (real time) scene, such as avoiding a walking pedestrian that may be detected ahead of or in the path of travel of the vehicle.

Static maps, such as, for example, maps of a parking structure provided by the owner over Wi-Fi, cannot show non-static objects due to not having real time entries. This is because the parking structure is typically not equipped with a mass of nowadays highly expansive sensors, which may be able to feed real time object data into a real time scene map and to transmit these on time. The automated navigating of a vehicle through the parking structure's static scene is a challenge by itself, also when a static map is provided (which often is not), since the ego motion of the vehicle is limited due to lacking the GPS signal and/or an ANIS signal. Optionally, an inertial measurement system (INS) may be present that is a combination of gyroscopes and accelerometers processed via an onboard processor. INS can measure the relative movement in position and angle of the vehicle, but not the absolute values. Thus, the INS needs to have a given start position so that absolute positions can be calculated out of relative motion measurements over time. ANIS units are GPS supported INS for overcoming shortcomings of the INS, recalibrating the absolute position when available. The ego motion detection is reduced to the (fusion of) wheel speed and steering angle sensing, and optionally present INS, LIDAR, RADAR, ultrasound sensor and camera data input. For example, in tunnels there are just a few reference objects (or shapes) to be detected by the sensors. The way determination by wheel speed, steering angle and INS adds up more and more (jitter) error over the distance, which can lead to a substantial error (being substantially off the assumed position), and which is too high for aided, automated and semi-automated guiding or driving systems to orientate reliably, which forces the system to hand over the driving task to a human driver, when present, or to fail.

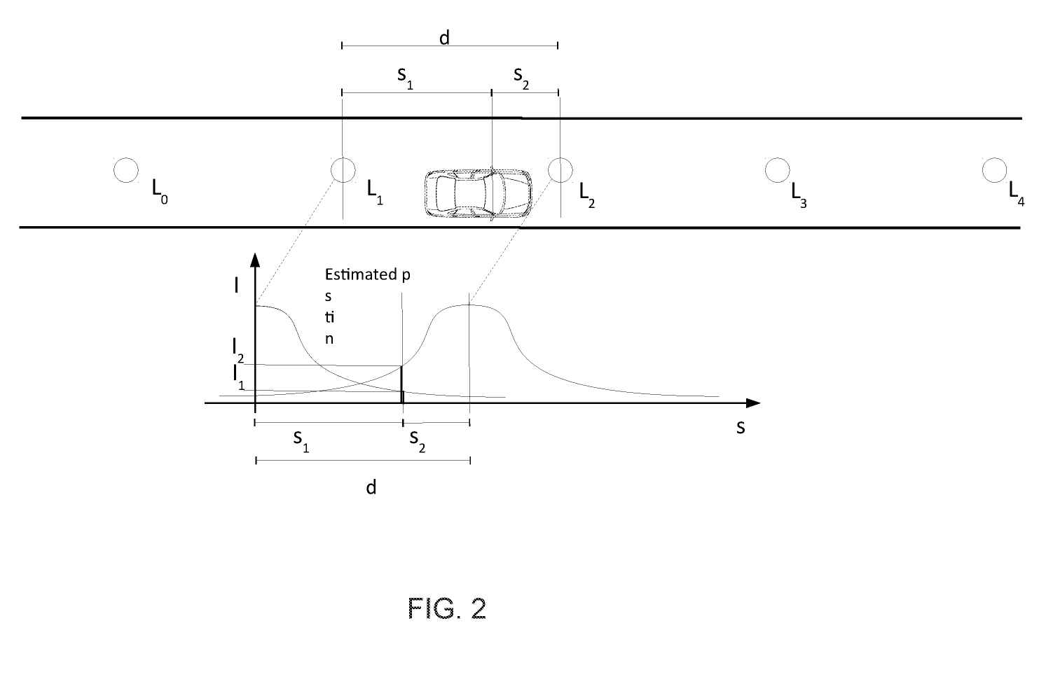

To solve this by a first solution in accordance with the present invention, a structure local positioning system may increase the positioning accuracy for enabling aided, automated and semi-automated driving systems to orient the vehicle's location reliably. The system includes LED (or other suitable emitters) lamps, which may be installed at the ceiling, walls or at the bottom of the structure that act as positioning reference points by broadcasting its exact own position (such as its position relative to other known positions at the structure or relative to a particular reference point at the structure or the like). Optionally, the position information may be broadcast in a GPS like format and/or according a GPS grid, optionally the format may be truncated with the LSBs remaining. Optionally, there may be one GPS position set as a reference, such as, for example, at the tunnel's or parking structure's entrance to which the lamp coordinates are referenced to (as difference vectors), optionally permanently repeating, over a light signal or pattern (positioning light signal lamp (PLSL)). As shown in FIG. 2, a vehicle may be driven through a tunnel with a plurality of PLSLs (L₀, L₁, L₂, etc.) installed on the ceiling of the tunnel. Each lamp is more or less a Lambertian emitter and has a steradian of light illuminating the ground underneath. The luminance “l” diminishes with the distance “s” in a lamp optics' specific assumingly known manner. The vehicle may detect the light intensity and the transmitted data from the lamps by a sensor or photodiode installed at the vehicle, such as at an upper region of the windshield (or at a top part of the vehicle so as to receive data from all directions around the vehicle, or such as at any other suitable location on the vehicle) or by a camera or any suitable photo detecting element (PDE). When more than one PLSL is in detection range of the PDE, the system of the present invention may detect the light intensity of both PLSLs. By knowledge of the light intensity to distance characteristic of the PLSLs, the system can determine the distance to each of both lights, and thus can determine the location of the vehicle relative to both of the lights and the positions of the lights. In the example of FIG. 2, there is a characteristic distance s1 according the detected light intensity 11 of the PLSL L1 and characteristic distance s2 according the detected light intensity 12 of the PLSL L2. Both light sources of 11 and 12 can be distinguished by the different data both broadcast. The distance “d” between the PLSLs is given by the difference in absolute position of both PLSL broadcasts. The light intensity may be measured analog or via timed binning.

Optionally, and in accordance with a second solution of the present invention, the PDE may have the capability to measure the angles each PLSL appears against the PDE's normal (optionally calibrated by the vehicle inherent gyro sensors (tilt, yaw, roll) under consideration of its own height over ground). By that, the vehicle's system can detect its fine position between the PLSLs by triangulation. This may be done when the PDE is a camera with a fish eye lens or the like, having an opening angle that extends to the vehicle over top, similar to cameras known for traffic light sensing. The angles can be read out from where the PLSL appears or where multiple PLSLs appear in the camera image.

The PDE may comprise an array of photodiodes with an angle selective sensitivity, optionally being done by having a sphere like arrangement of photodiodes which have separators or angled slots between one another to block light which is beyond a limited angle, having the slotted photodiodes distributed in an order covering the whole relevant detection angle. As an alternative to the sphere of separated photodiodes, there may be an optical element separating the incoming light from different angle intervals into different photodiodes, such as a sphere lens array of convex lenses does with one photodiode underneath each or alternatively using a volume hologram, such as by utilizing aspects of the systems described in U.S. patent application Ser. No. 15/490,172, filed Apr. 18, 2017 (Attorney Docket MAG04 P-3006), which is hereby incorporated herein by reference in its entirety. Optionally, the system may include a forward sensing PDE and a rearward sensing PDE that sense regions ahead of and behind the vehicle as the vehicle travels through the structure, since such sensing would capture signals emitted by relevant PLSLs ahead of and behind the vehicle.

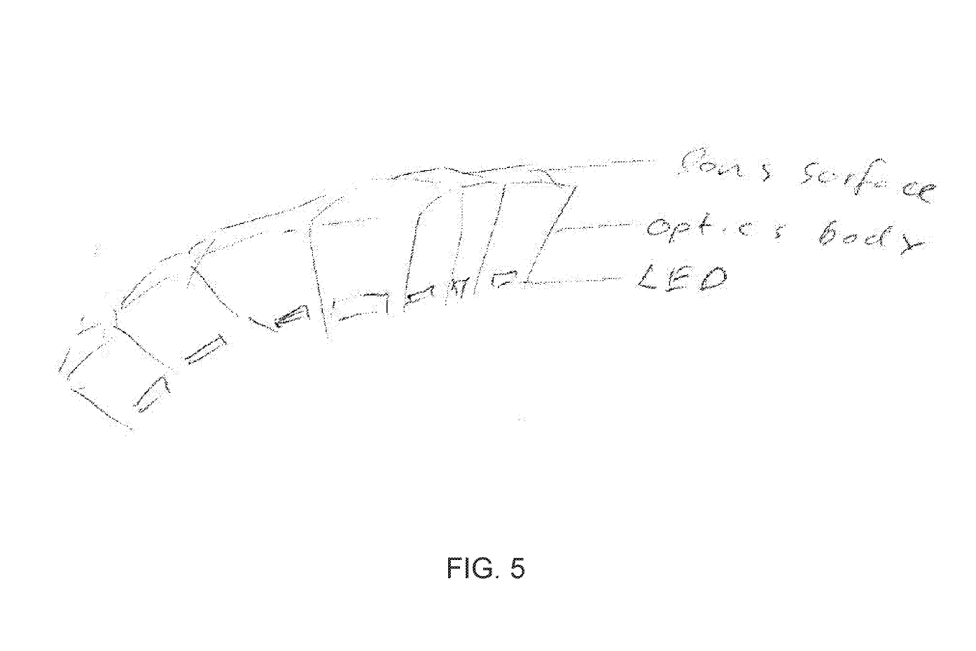

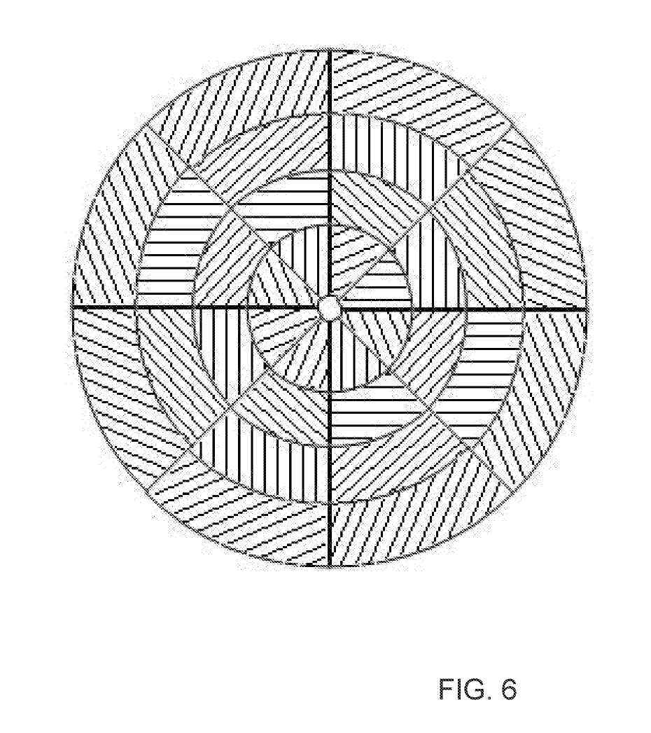

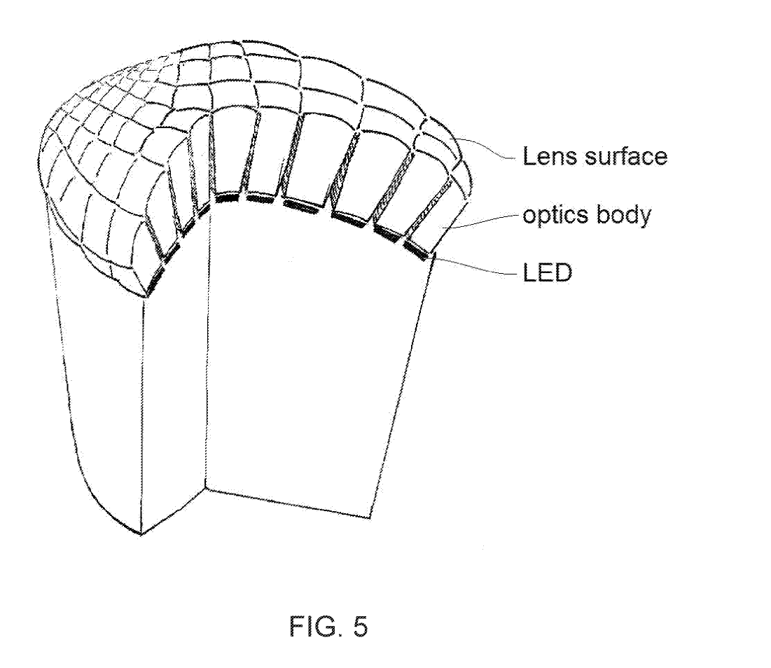

Optionally, and as a third solution in accordance with the present invention, it is not the detecting PDE that is angle selective, but the PLSL provides angle incorporating data. As shown in FIG. 5, the PLSL may have a sphere (or partial sphere) of LEDs or an optical element which spreads the light from the lamps LEDs in a sphere like (or partial sphere like) manner. Typical LED optics are made in a way and classified by their opening angle. The light emitted beyond the opening angle is quite limited, by that LEDs have an angle selective behavior by nature. The LED's position and optics may be chosen so that a light beam of one LED ends next to where a neighbored LED begins, so that there is no overlap or just a little overlap between each LED's light beams and the whole sphere space covered by illumination. This is different from the solutions above where each lamp sends just one positioning information. In the third solution, each diode of one lamp may send the lamp's position plus an angle information. The vehicle mounted PDE may process the information of the incoming PLSLs, by that it instantly detects the angle towards each PLSL (such as when the PLSL signal is first detected) without the need to be capable of measuring the angle of the incoming light by any means directly. Triangulation is possible by that.

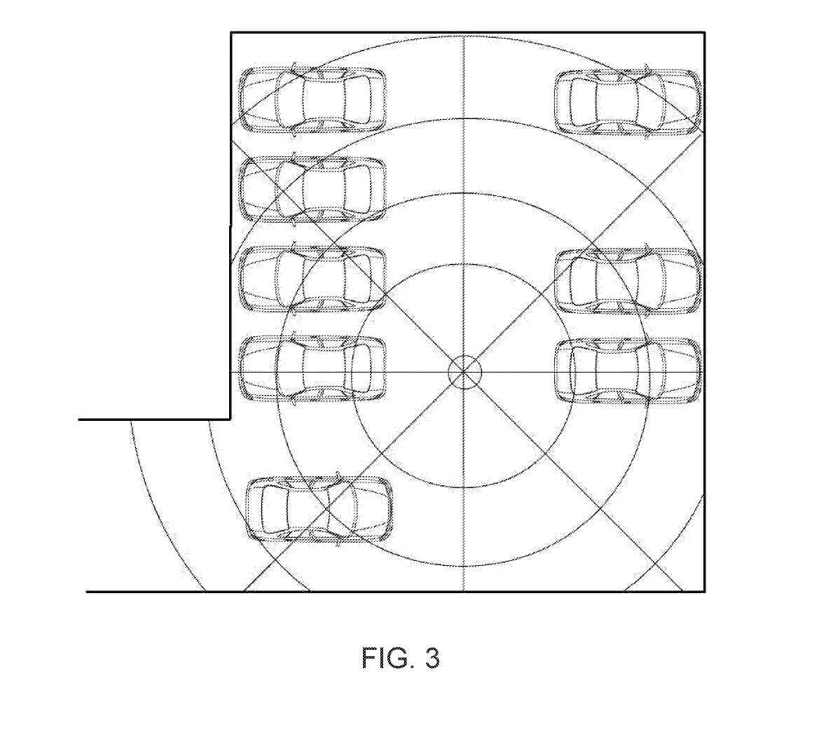

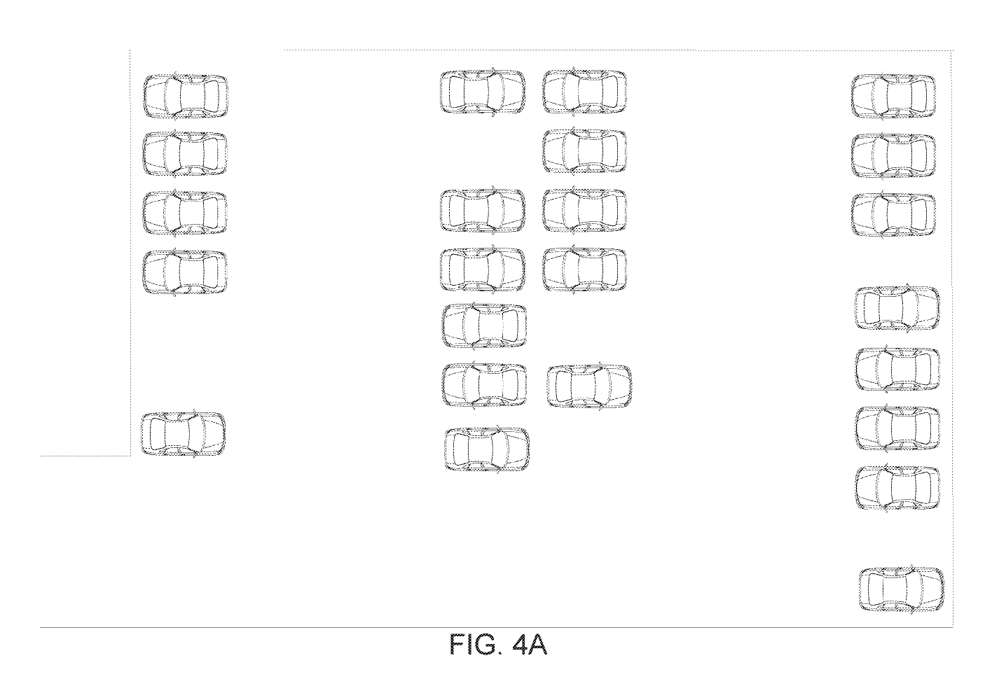

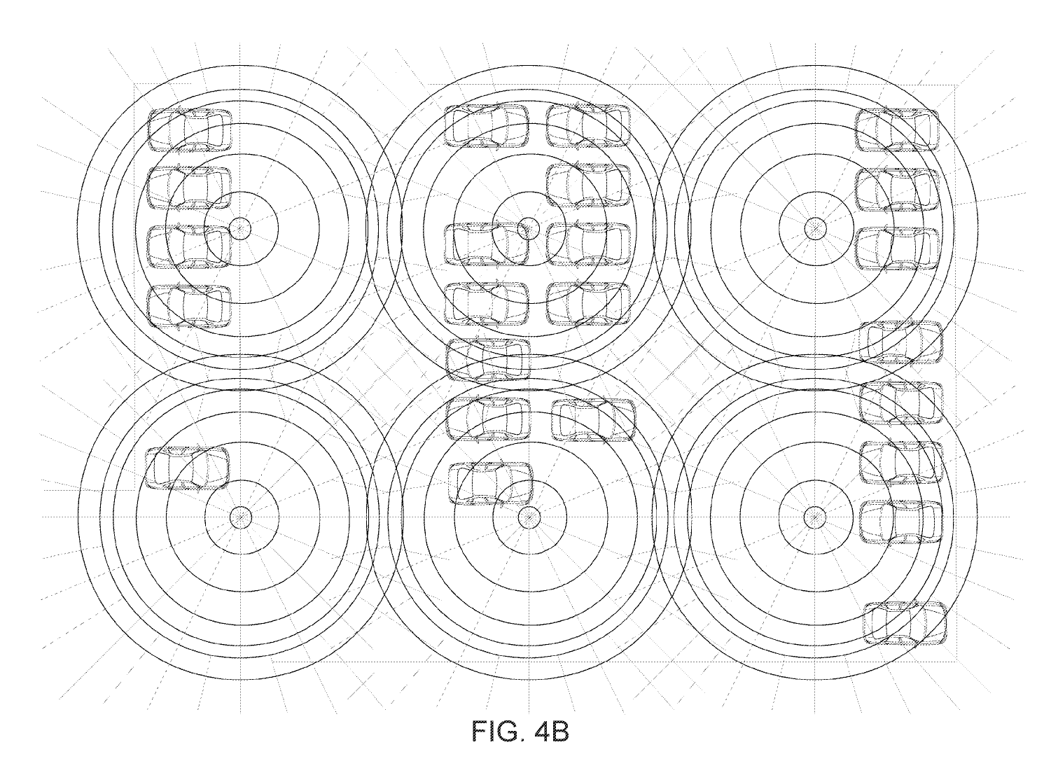

FIG. 3 shows a parking structure lamp of a system in accordance with solution three with the illuminated segments increasing in space with the distance. As an option of solution three of the present invention, the opening angles of the lamp's LEDs may be done in a way that those in the center have a wider angle or a bigger surface than those illumination more sidewardly, such as shown in FIG. 4B. In FIG. 4B there are six partially overlapping lamps. FIG. 4A shows the parking structure scene of FIG. 4B without the lamps. By that the positioning resolution may not decrease more and more with increasing distance to a lamp.

Optionally, with respect to the third solution, for a more precise distinguishing the sections, each LED segment's area may additionally possess a light polarization property, all in substantially different polarization angles to one another, optionally done by using polarization filters. Optionally, the LED is configured in a way to emit polarized light by its nature without the need of a filter. FIG. 6 shows a polarization scheme of illuminated segments around a PLSL in example. The detecting PDE may comprise means for detecting the different polarization directions by polarization angle filtering. Optionally, different pixel or pixel areas may comprise different polarized filters or optionally there may be rotating polarization filter within the camera optics filtering the different polarization directions in a timely consecutive fashion. Optionally, the polarized light distinguishing may also serve the purpose to widen the data communication bandwidths.

As another option, the lamps may interchange data by light signaling, by having photodiodes for receiving data by themselves. Optionally, vehicles equipped with cameras and/or optionally additional sensors and a bidirectional wireless data communication may report or broadcast free parking spots to the structures optical wireless data grid or any other conventional electromagnetic radio data channel. The free parking spots may be received by just arriving vehicles requesting directions to a free spot or optionally stored by any means such as a cloud service (which does without extra equipment of the served area such as the parking garage) or a server attached to the parking structure's wireless grid for providing free parking spots on later requests. Optionally, the free spot reporting system may also be triggered when one equipped vehicle leaves. Since equipped vehicles may also report free spots they pass while navigating to their designated spot, the structure's server may also be able to supervise nearly all free spots even when just a minority of vehicles entering the parking structure are equipped with bidirectional optical data transmission, which eases the acceptance and market introduction of such a system. Although the free parking spot determination will increase in completeness and timely accuracy as more entering vehicles are equipped.

Thus, when a vehicle equipped with the system of the present invention enters a parking structure, the vehicle may receive a signal indicative of an available parking space. The system may then control the vehicle to autonomously maneuver the vehicle through the parking structure towards and into the available parking space by sequentially detecting a plurality of light sources that are emitting the optical signals, since, upon receiving an optical signal from the light sources, the system determines the location of the vehicle within the parking structure and can maneuver the vehicle toward the next light source, whereupon the system will receive the optical signals emitted by that light source to determine the current location of the vehicle within the parking structure. This process can be repeated until the vehicle is at the selected or available parking space.

In U.S. Publication No. US-2016-0162747, which is hereby incorporated herein by reference in its entirety, the detection of a motion pattern of passive (reflected) lights or retroreflectors, such as the motion pattern of a cyclist, especially the motion pattern of the bicycle's spoke reflectors, is described, along with the detection of dedicated key markers or known visual cues of naturally or artificial present objects or shapes or dedicated pattern or shapes. Particularly, the detection of visual codes such as bar codes (such as RSS-14, UPC-E, Code ITF 2/5) or two dimensional (2D) codes (such as Aztec, Vericode, QR, Array Tag, Dot Code A, MaxiCode, SmartCode, Snowflake Code or Color Ultra Code) is described in U.S. Publication No. US-2016-0162747. The detection of static retro reflective code patterns suitable to act as a reference for the vehicle's ego positioning, redundant to GPS, was described in U.S. Publication No. US-2016-0162747 as well.

The above incorporated U.S. patent application Ser. No. 15/376,818 describes passive changing patterns as well as active illuminated static or changing patterns used for vehicle tagging to improve the false negative rate of active high beam control (AHBC) systems by providing better vehicle identification.

As an optional additional solution of the present invention, passively reflecting static road or way markings as well as actively illuminated road or way markings (such as suggested in U.S. Publication No. US-2016-0162747), preferably two dimensional (2D) pattern may come into use in combination with PLSLs to enable or improve the positioning accuracy of aided, automated and semi-automated vehicle driving or guiding systems on roads and especially within structures. The markings may be attached in a height well conceivable by the vehicle PDEs, such as over top for light sensor diodes or at about a half vehicle height for cameras. When driving in structures, the vehicle system or control may optionally turn on all cameras for which image processing systems are capable for PLSL decoding and/or static road or way marking interpretation for the highest redundancy. Each posted pattern or marking may be unique such that the system, upon detection of a pattern or marking (and optionally determining an angle and distance to the detected pattern or marking), may determine the vehicle location within the structure. Optionally, the PLSL may both work independent to or with a superior system employing a fusion of both positioning algorithms optionally with having the conventional positioning (wheel speed plus steering angle, GPS sensors or ANIS sensors or the like) system fused into as well.

Therefore, the present invention provides a vehicle optical wireless data communication system that provides location information to vehicles when the vehicles are driven in areas that do not allow for GPS systems to work effectively, such as parking structures and tunnels and the like. The communication system may operate when the vehicle's GPS does not function properly (and may be activated responsive to a determination that the GPS signals are insufficient to determine the vehicle's location accurately). The sensor of the vehicle detects the optical communication from light sources at a structure (such as a tunnel or parking structure or the like) and processes the signal to extract the information broadcast therein, such as the geographical location of that particular light source or the location of that particular light source relative to another light source at that structure or the like. The light sources also provide visible light to illuminate the structure (tunnel or parking structure or the like).

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EyeQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ladar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in International Publication Nos. WO 2010/144900; WO 2013/043661 and/or WO 2013/081985, and/or U.S. Pat. No. 9,126,525, which are hereby incorporated herein by reference in their entireties.

The system may also communicate with other systems, such as via a vehicle-to-vehicle communication system or a vehicle-to-infrastructure communication system or the like. Such car2car or vehicle to vehicle (V2V) and vehicle-to-infrastructure (car2X or V2X or V2I or 4G or 5G) technology provides for communication between vehicles and/or infrastructure based on information provided by one or more vehicles and/or information provided by a remote server or the like. Such vehicle communication systems may utilize aspects of the systems described in U.S. Pat. Nos. 6,690,268; 6,693,517 and/or 7,580,795, and/or U.S. Publication Nos. US-2016-0210853; US-2014-0375476; US-2014-0218529; US-2013-0222592; US-2012-0218412; US-2012-0062743; US-2015-0251599; US-2015-0158499; US-2015-0124096; US-2015-0352953 and/or US-2016-0036917, which are hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device, such as by utilizing aspects of the video display systems described in U.S. Pat. Nos. 5,530,240; 6,329,925; 7,855,755; 7,626,749; 7,581,859; 7,446,650; 7,338,177; 7,274,501; 7,255,451; 7,195,381; 7,184,190; 5,668,663; 5,724,187; 6,690,268; 7,370,983; 7,329,013; 7,308,341; 7,289,037; 7,249,860; 7,004,593; 4,546,551; 5,699,044; 4,953,305; 5,576,687; 5,632,092; 5,677,851; 5,708,410; 5,737,226; 5,802,727; 5,878,370; 6,087,953; 6,173,508; 6,222,460; 6,513,252 and/or 6,642,851, and/or U.S. Publication Nos. US-2012-0162427; US-2006-0050018 and/or US-2006-0061008, which are all hereby incorporated herein by reference in their entireties. Optionally, the vision system (utilizing the forward facing camera and a rearward facing camera and other cameras disposed at the vehicle with exterior fields of view) may be part of or may provide a display of a top-down view or birds-eye view system of the vehicle or a surround view at the vehicle, such as by utilizing aspects of the vision systems described in International Publication Nos. WO 2010/099416; WO 2011/028686; WO 2012/075250; WO 2013/019795; WO 2012/075250; WO 2012/145822; WO 2013/081985; WO 2013/086249 and/or WO 2013/109869, and/or U.S. Publication No. US-2012-0162427, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicle optical wireless data communication system comprising:
a plurality of light sources disposed at a structure where vehicles travel;
wherein each of said light sources emits visible light to illuminate the structure;
wherein each of said light sources emits optical signals indicative of a location of the respective light source;
a sensor disposed at a vehicle and operable to sense optical signals emitted by said light sources when the vehicle is in the vicinity of said light sources;
wherein, responsive to sensing by said sensor of optical signals emitted by at least one of said light sources, said sensor generates an output to a processor disposed at the vehicle; and
wherein said processor processes the output of said sensor to determine a location of the vehicle relative to at least one of said light sources.

2. The optical wireless data communication system of claim 1, wherein said light sources are disposed at a parking structure.

3. The optical wireless data communication system of claim 2, wherein said light sources emit optical signals that include parking space availability information pertaining to parking spaces of the parking structure.

4. The optical wireless data communication system of claim 1, wherein said light sources are disposed at a tunnel.

5. The optical wireless data communication system of claim 1, wherein said light sources emit optical signals that include location and angle information.

6. The optical wireless data communication system of claim 1, wherein said light sources emit optical signals that are indicative of the location of the respective light source relative to a reference point of the structure.

7. The optical wireless data communication system of claim 1, wherein said processor processes the output of said sensor to determine an angle relative to a sensed one of said light sources.

8. The optical wireless data communication system of claim 7, wherein each of said light sources emits optical signals within an angular range.

9. The optical wireless data communication system of claim 1, wherein said sensor comprises a 360 degree sensing device that senses optical signals emitted from any direction around the vehicle.

10. The optical wireless data communication system of claim 1, wherein said system is operable to determine distance to a light source responsive to determination of an intensity of the received optical signal and a known intensity property of the emitted optical signal.

11. The optical wireless data communication system of claim 10, wherein, responsive to receiving optical signals emitted by two or more light sources, said system can determine distance to each of the light sources to determine the location of the vehicle relative to both of the light sources.

12. A vehicle optical wireless data communication system comprising:
a plurality of light sources disposed at a structure where vehicles travel, wherein said light sources are disposed at a parking structure;
wherein each of said light sources emits visible light to illuminate the parking structure;
wherein each of said light sources emits optical signals indicative of a location of the respective light source relative to a reference point of the parking structure;
a sensor disposed at a vehicle and operable to sense optical signals emitted by said light sources when the vehicle is in the vicinity of said light sources;
wherein, responsive to sensing by said sensor of optical signals emitted by at least one of said light sources, said sensor generates an output to a processor disposed at the vehicle; and
wherein said processor processes the output of said sensor to determine a location of the vehicle relative to at least one of said light sources.

13. The optical wireless data communication system of claim 12, wherein said light sources emit optical signals that include parking space availability information pertaining to parking spaces of the parking structure.

14. The optical wireless data communication system of claim 12, wherein said light sources emit optical signals that include location and angle information.

15. The optical wireless data communication system of claim 12, wherein said sensor comprises a 360 degree sensing device that senses optical signals emitted from any direction around the vehicle.

16. The optical wireless data communication system of claim 12, wherein said processor processes outputs of said sensor as the vehicle is maneuvered through the parking structure to continuously determine the current location of the vehicle within the parking structure.

17. A vehicle optical wireless data communication system comprising:
a plurality of light sources disposed at a structure where vehicles travel;
wherein each of said light sources emits visible light to illuminate the structure;
wherein each of said light sources emits optical signals indicative of a location of the respective light source;
a sensor disposed at a vehicle and operable to sense optical signals emitted by said light sources when the vehicle is in the vicinity of said light sources;
wherein, responsive to sensing by said sensor of optical signals emitted by at least one of said light sources, said sensor generates an output to a processor disposed at the vehicle;
wherein said processor processes the output of said sensor to determine a location of the vehicle relative to at least one of said light sources;
wherein said system is operable to determine distance to a light source responsive to determination of an intensity of the received optical signal and a known intensity property of the emitted optical signal;
wherein, responsive to receiving optical signals emitted by two or more light sources, said system can determine distance to each of the light sources to determine the location of the vehicle relative to both of the light sources; and
wherein said processor processes outputs of said sensor as the vehicle is maneuvered relative to the structure to continuously determine the current location of the vehicle at the structure.

18. The optical wireless data communication system of claim 17, wherein said light sources are disposed at a parking structure, and wherein said light sources emit optical signals that include parking space availability information pertaining to parking spaces of the parking structure.

19. The optical wireless data communication system of claim 17, wherein said light sources are disposed at a tunnel.

20. The optical wireless data communication system of claim 17, wherein said processor processes the output of said sensor to determine an angle relative to a sensed one of said light sources.
